(19) United States
(12) Patent Application Publication
(10) Pub. No.: US 2023/0283117 A1
(43) Pub. Date: Sep. 7, 2023

(54) POWER CONTROLLER IN A WIRELESS POWER RECEPTION APPARATUS

(71) Applicant: General Electric Company, Schenectady, NY (US)

(72) Inventors: Jayanti Ganesh, Bangalore (IN); Rupam Basak, Bangalore (IN); Viswanathan Kanakasabai, Bangalore (IN)

(21) Appl. No.: 18/006,208

(22) PCT Filed: Jul. 16, 2021
(86) PCT No.: PCT/US21/42085

§ 371 Date: Jan. 20, 2023

(30) Foreign Application Priority Data
Jul. 20, 2020 (IN) 202011030957

(51) Int. Cl. H02J 50/40; H02J 50/80; H02J 50/90; H02J 7/00; H02J 50/10

(52) U.S. Cl. CPC H02J 50/402; H02J 50/80; H02J 50/90; H02J 7/00714; H02J 50/10

(57) ABSTRACT

This disclosure provides systems, methods, and apparatuses for wireless power reception. Various implementations relate generally to a wireless power reception apparatus including multiple secondary coils that receive wireless power from corresponding primary coils of a wireless power transmission apparatus. When a secondary coil receives power form a primary coil, they form a latched coil pair. Initially, the wireless power reception apparatus receives via a number of latched coil pairs. Coil pairs may de-latch as they physically move out of alignment. If one or more coil pairs de-latch, voltage may drop in the latched coil pairs. The wireless power reception apparatus includes a power controller that can detect drops in voltage resulting from de-latching coil pairs. In response, the power controller can modify current drawn from the remaining latched coil pairs. By modifying current drawn from the remaining latched coil pairs, the power controller can avoid system failure.

### TECHNICAL FIELD

This disclosure relates generally to wireless power. More specifically, this application relates to a wireless power reception apparatus.

### DESCRIPTION OF RELATED TECHNOLOGY

Conventional wireless power systems have been developed with a primary objective of charging a battery in a wireless power reception apparatus. In a conventional wireless power system, a wireless power transmission apparatus may include a primary coil that produces an electromagnetic field. The electromagnetic field may induce a voltage in a secondary coil of a wireless power reception apparatus when the secondary coil is placed in proximity to the primary coil. In this configuration, the electromagnetic field may transfer power to the secondary coil wirelessly. The power may be transferred using resonant or non-resonant inductive coupling between the primary coil and the secondary coil. The wireless power reception apparatus may use the received power to operate or may store the received energy in a battery for later use.

### SUMMARY

The systems, methods, and apparatuses of this disclosure each have several innovative aspects, no single one of which is solely responsible for the desirable attributes disclosed herein.

One innovative aspect of the subject matter described in this disclosure can be implemented in a wireless power reception apparatus. In some implementations, the wireless power reception apparatus may include a plurality of secondary coils that can receive wireless power from at least one primary coil of a wireless power transmission apparatus and provide the wireless power to a power combination circuit. The wireless power reception apparatus also may include a power combination circuit configured to combine the wireless power received by the plurality of secondary coils and provide a combined power to a power regulating circuit. The power regulating circuit may be configured to receive the combined power from the power combination circuit and provide a power output to a load. The wireless power reception apparatus also may include a power controller configured to control the power output of the power regulating circuit based, at least in part, on a quantity of secondary coils, from among the plurality of secondary coils, that are latched with different primary coils of the wireless power transmission apparatus.

In some implementations, the wireless power reception apparatus may be further configured to determine the quantity of secondary coils that are latched with different primary coils of the wireless power transmission apparatus, and determine a rectified voltage received from the quantity of secondary coils that are latched.

In some implementations, the power controller may be further configured to determine the quantity of secondary coils that are latched, and control the power output of the power regulating circuit by controlling a current limiting switch of the power regulating circuit.

In some implementations, the power output may be provided to a battery managed by a battery management system.

In some implementations, the power controller may be further configured to communicate information about the power output to the battery management system.

In some implementations, the power controller may be further configured to receive information about the quantity of secondary coils that are latched with different primary coils of the wireless power transmission apparatus from a receiver status sensor that receives information from sensors associated with the secondary coils.

In some implementations, the power controller may be further configured to detect de-latching of one or more of the secondary coils from a corresponding primary coil of the wireless power transmission apparatus, and adjust the power output of the power regulating circuit based on how many of the secondary coils remain latched as a result of the de-latching of the one or more secondary coils.

In some implementations, the power controller may be further configured to determine how many secondary coils remain latched with corresponding primary coils of the wireless power transmission apparatus, and disconnect one or more of the latched secondary coils while continuing to maintain the power output provided by the remaining latched secondary coils.

Another innovative aspect of the subject matter described in this disclosure can be implemented in a wireless power reception apparatus. In some implementations, the wireless power reception apparatus may include a plurality of secondary coils, each secondary coil configured to receive wireless power from one or more primary coils of a wireless power transmission apparatus and to provide the wireless power to a power combination circuit. The power combination circuit may be configured to combine the wireless power received by a quantity of secondary coils and provide a combined power to a power regulating circuit. The power regulating circuit may be configured to receive the combined power from the power combination circuit and provide a power output to a load. The wireless power reception apparatus also may include a power controller configured to control one or more switches of the power regulation circuit to control the power output of the power regulating circuit based on a demanded current associated with the load.

In some implementations, the power controller is further configured to determine the demanded current associated with the load, and determine a quantity of secondary coils to receive wireless power based, at least in part, on the demanded current associated with the load.

In some implementations, the wireless power reception may further include one or more receiver controllers configured to manage the plurality of secondary coils, wherein the power controller is further configured to communicate with the one or more receiver controllers to cause the quantity of secondary coils to receive the wireless power from one or more corresponding primary coils.

In some implementations, the power controller may be further configured to cause the quantity of secondary coils to remain latched to corresponding primary coils, and cause one or more other secondary coils of the plurality of secondary coils to switch off.

In some implementations, the load may include a battery managed by a battery management system, and the power controller is further configured to receive information about the demanded current associated with the load from the battery management system.

In some implementations, the power controller may be further configured to determine a gate pulse for the one or more switches of the power regulating circuit based, at least in part, on the demanded current associated with the load.

Another innovative aspect of the subject matter described in this disclosure can be implemented as a method performed by a wireless power reception apparatus including a plurality of secondary coils. The method may include latching, by one or more of the secondary coils, to corresponding primary coils of a wireless power transmission apparatus, where each of the latched secondary coils receives wireless power from a different primary coil. The method also may include determining, by a power controller, a quantity of the secondary coils that have latched from a corresponding primary coil. The method also may include combining, by a power combination circuit, the wireless power received by each of the quantity of secondary coils to provide a combined power to a power regulating circuit. The method also may include determining, by the power controller, a rectified voltage received from the quantity of secondary coils that are latched. The method also may include controlling, by the power controller, a power output of the power regulating circuit based, at least in part, on the quantity of secondary coils that are latched and the rectified voltage. The method also may include providing, by the power regulating circuit, the power output to a load.

In some implementations, controlling the power output of the power regulating circuit further includes determining, by the power controller, a gate pulse based, at least in part, on the quantity of secondary coils that are latched, and controlling a current controlling switch of the power regulating circuit based on the gate pulse.

In some implementations, the method may further include receiving, by the power controller, information about the quantity of secondary coils that are latched with different primary coils of the wireless power transmission apparatus from a receiver status sensor that receives information from sensors associated with the secondary coils.

In some implementations, the method may further include detecting a de-latching of one or more of the secondary coils from a corresponding primary coil of the wireless power transmission apparatus, and controlling the power output of the power regulating circuit based on how many of the secondary coils remain latched as a result of the de-latching of the one or more secondary coils.

In some implementations, the method may further include determining how many secondary coils remain latched with corresponding primary coils of the wireless power transmission apparatus, and reducing, by the power controller, a current of the power output of the power regulating circuit based, at least in part, on how many secondary coils remain latched, and providing the power output at the reduced current to the load.

Another innovative aspect of the subject matter described in this disclosure can be implemented as a method performed by a wireless power reception apparatus including a plurality of secondary coils. The method may include receiving, by one or more of the secondary coils, wireless power from corresponding primary coils of a wireless power transmission apparatus. The method also may include combining, by a power combination circuit, the wireless power received by a quantity of secondary coils to provide a combined power to a power regulating circuit. The method also may include determining, by a power controller, a demanded current associated with the load. The method also may include controlling, by the power controller, one or more switches of the power regulating circuit based on the demanded current associated with the load. The method also may include providing, by the power regulating circuit, the power output to the load.

In some implementations, the method may further include determining, by the power controller, the quantity of secondary coils to receive wireless power based, at least in part, on the demanded current associated with the load.

In some implementations, the plurality of secondary coils may be managed by one or more receiver controllers, and the method may further include communicating, by the power controller, with the one or more receiver controllers to cause the quantity of secondary coils to receive the wireless power from one or more corresponding primary coils.

In some implementations, the communicating with the one or more receiver controllers may further include sending a signal from the power controller to the one or more receiver controllers to cause the quantity of secondary coils to remain latched to corresponding primary coils, and sending a signal from the power controller to the one or more receiver controllers to cause one or more other secondary coils of the plurality of secondary coils to switch off.

In some implementations, the method may further include determining, by the power controller, a gate pulse based, at least in part, on the demanded current, wherein the controlling one or more switches includes controlling, by the power controller, a current controlling switch of the power regulation circuit based on the gate pulse to provide the power output.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 is a block diagram illustrating components associated with an example wireless power system according to some implementations.

FIG. 2 shows an example wireless power system that includes a wireless power reception apparatus capable of receiving power from multiple primary coils of a wireless power transmission apparatus according to some implementations.

FIG. 3 shows an example wireless power system in which a wireless power transmission apparatus includes multiple layers of primary coils arranged in an overlapping pattern according to some implementations.

FIG. 4 shows an example wireless power system in which a wireless power reception apparatus is configured to provide power to an electronic device according to some implementations.

FIG. 5 is a block diagram illustrating components of an example wireless power reception apparatus according to some implementations.

FIG. 6 is an example data flow diagram illustrating data and components used regulating the current and voltage output of a power regulating circuit according to some implementations.

FIG. 7A illustrates an example graph showing voltage in a wireless power reception apparatus according to some implementations.

FIG. 7B illustrates an example graph showing output voltage of a power regulating circuit in a wireless power reception apparatus according to some implementations.

FIG. 8A illustrates an example graph showing output current of two secondary coils.

FIG. 8B illustrates an example graph of a demanded current of a battery management system (BMS) according to some implementations.

FIG. 8C illustrates an example graph showing output power of a wireless power reception apparatus according to some implementations.

FIG. 9A illustrates an example graph showing Rx output voltage and DC-DC converter output voltage in a wireless power reception apparatus.

FIG. 9B illustrates an example graph showing current output of two secondary coils and a demanded current of a BMS, according to some implementations.

FIG. 10 is a flow diagram illustrating example operations for controlling a wireless power transmission apparatus according to some implementations.

FIG. 11 is a flow diagram illustrating example operations for controlling a wireless power transmission apparatus according to some implementations.

FIG. 12 shows a block diagram of an example apparatus for use in wireless power system according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A traditional wireless power system may include a wireless power transmission apparatus and a wireless power reception apparatus. The wireless power transmission apparatus may include a primary coil that transmits wireless energy (as a wireless power signal) to a corresponding secondary coil in the wireless power reception apparatus. A primary coil refers to a source of wireless energy (such as inductive or magnetic resonant energy) in a wireless power transmission apparatus. A secondary coil is located in a wireless power reception apparatus and receives the wireless energy. Wireless power transmission is more efficient when the primary and secondary coils are closely positioned. Conversely, the efficiency may decrease (or the charging may cease) when the primary and secondary coils are misaligned. When properly aligned, primary coils and secondary coils can transfer wireless energy up to an amount predetermined by a wireless standard. For example, a wireless power signal may convey 5 Watts (W), 9 W, 12 W, 15 W, or more. Recently, some wireless power reception apparatuses are configured to combine power provided by multiple coil pairs to produce an overall power output to a load (such as a battery or other electronics of the wireless power reception apparatus). A coil pair may refer to the combination of a primary coil in a wireless power transmission apparatus and a secondary coil in a wireless power reception apparatus.

This disclosure provides systems, methods, and apparatuses for wireless power reception. Various implementations relate generally to a wireless power reception apparatus including multiple secondary coils that receive wireless power from corresponding primary coils of a wireless power transmission apparatus. In some implementations, a power controller of the wireless power reception apparatus may manage the overall power provided by the multiple coil pairs based on which coil pairs are latched. Latching may occur after certain conditions are met such as after a secondary coil and a corresponding primary coil are aligned and power information is exchanged between them. Among other things, this disclosure describes a power controller that can manage power combined from multiple coil pairs and can adjust power reception based on a detection of a de-latched coil pair, the total quantity of latched coil pairs, the demanded current of a load, or any combination thereof.

In some implementations, the power controller can detect a de-latching of one or more of the latched coil pairs. For example, a coil pair may de-latch if the primary and secondary coils are moved out of alignment and end power transfer. In another aspect, the primary and secondary coils may de-latch under fault conditions such as overly high temperature and overly high current in the coils or associated electronics. An overly high temperature or overly high current may be defined as a temperature or current being above a temperature threshold or a current threshold, respectively. As one or more coil pairs de-latch, the combined voltage provided by the remaining latched coil pairs may drop causing the remaining coil pairs to draw more power to meet load demand and possibly enter an fault condition in which all the coil pairs may de-latch. In some implementations, the power controller may detect such a voltage drop and modify an amount of power provided by the remaining latched coil pairs to the load. By modifying the amount of power, the power controller may avoid a system failure or de-latching of the remaining coil pairs. Thus, the power controller may enable the wireless power reception apparatus to continue providing power to the load, possibly at a lower power.

In some implementations, the power controller can detect that a load has reduced its demand for current. The amount of current that is demanded by the load may also be referred to as a demanded current, power demand, or a current demand. For example, the power controller may detect that a battery management system (BMS) has reduced its demanded current for charging a battery. The power controller may determine how many latched coil pairs are needed to meet the demanded current. The power controller can cause one or more secondary coils to switch-off based on the number of latched coil pairs needed to meet the demanded current. In some implementations, switching off a secondary coil may include communication from the wireless power reception apparatus to the wireless power transmission apparatus to cause the corresponding primary coil to cease transmission of wireless power. Alternatively, or additionally, switching off a secondary coil may include opening or breaking a circuit associated with the secondary coil to cause the secondary coil to cease reception of the wireless power. The power controller may notify one or more receiver controllers associated with the secondary coils about the reduced number of needed coil pairs. In response, one or more of the receiver controllers may control operation of the secondary coils so that fewer latched coil pairs will be used. Therefore, some implementations of the power controller enable combination of wireless power from fewer coil pairs to meet the demanded currents. Furthermore, in some implementations, the power controller can cause one or more secondary coils to draw a reduced amount of wireless power from the wireless power transmission apparatus commensurate with its contribution to the demanded current.

Particular implementations of the subject matter described in this disclosure can be implemented to realize one or more of the following potential advantages. In some implementations, the power controller of a wireless power reception apparatus may detect a voltage drop associated with de-latching secondary coils and modify an amount of power provided to a load. By modifying the amount of power, the power controller avoids system failure and enables the wireless power reception apparatus to continue charging the load. In some implementations, the power controller conserves power in response to reduced demanded currents. In some implementations, a power controller may use fewer latched coil pairs to meet demanded currents.

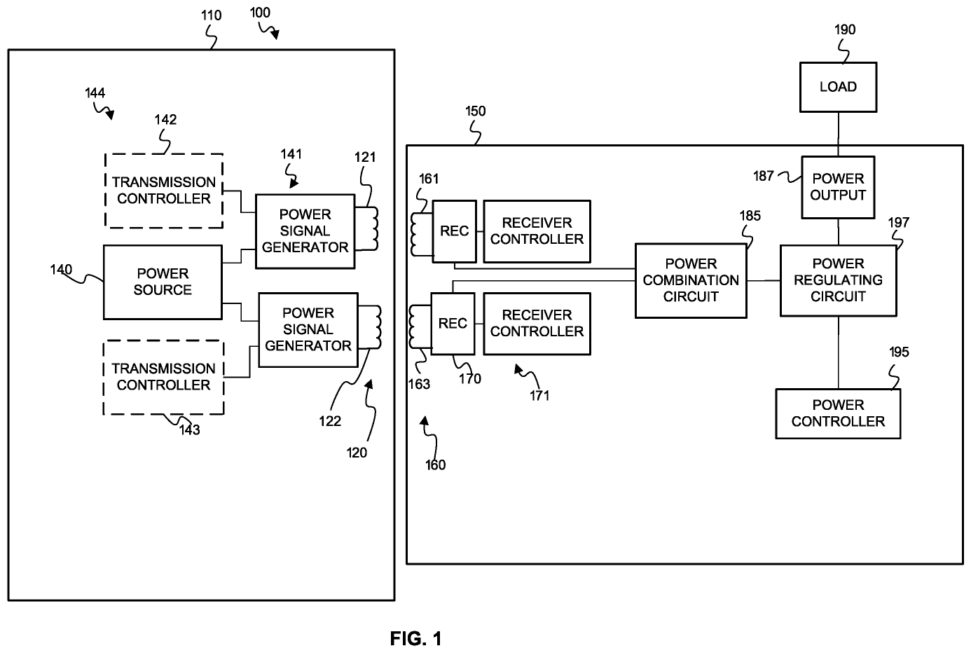

FIG. 1 is a block diagram illustrating example components associated with an example wireless power system according to some implementations. The wireless power system 100 includes a wireless power transmission apparatus 110 which has two primary coils 120. Each of the primary coils 120 may be associated with a power signal generator 141. Each primary coil 120 may be a wire coil which transmits a wireless power signal (which also may be referred to as wireless energy). The primary coils 120 may transmit wireless energy using inductive or magnetic resonant field. The power signal generators 141 may include components (not shown) to prepare the wireless power signal. For example, the power signal generators 141 may include one or more switches, drivers, a series capacitor, or other components. The wireless power transmission apparatus 110 may include a power source 140 which is configured to provide power to each transmission controller 144 in the wireless power transmission apparatus 110. A power source 140 may convert alternating current (AC) to direct current (DC).

The primary coils 120 may be managed by one or more transmission controllers 144 (such as communication and current/power controllers) that control whether the primary coil is transmitting wireless power. In some implementations, each primary coil 120 may be associated with a transmission controller 144, driver, voltage regulator, and the like. In some implementations, each primary coil 120 may be coupled with separate circuit components like a capacitor (in series with the primary coil), a current sensing resistor, or other elements. Each transmission controller 144 may determine whether to cause its associated primary coil 120 to transmit wireless power. For example, a transmission controller 142 may periodically activate a power signal generator 141 associated with the primary coil 121 (and series capacitor) to excite (or briefly energize) the primary coil 120. The transmission controller 142 may perform a coil current sensing process to determine if a wireless power reception apparatus 150 is located near the primary coil 121. If a wireless power reception apparatus 150 is detected, the transmission controller 142 may activate the power signal generator 141 to cause the primary coil 121 to transmit wireless power. In some implementations, a transmission controller 144 may independently manage more than one primary coil 120. A transmission controller 142 that receives a communication from the wireless power reception apparatus 150 in response to a ping action may determine that the wireless power reception apparatus 150 is in proximity to its primary coil 121 and will continue to maintain power to complete a hand-shaking process in which the transmission controller 142 receives information from the wireless power reception apparatus 150. For example, during the hand-shaking process, the transmission controller 142 may receive parameters for latching to the wireless power reception apparatus 150 such as signal strength, power level, manufacturer identifier, device identifier, or power rating, among other examples. After latching, the transmission controller 142 may cause its primary coil 121 to provide wireless energy to a secondary coil 161 of the wireless power reception apparatus 150. Other transmission controllers 144 that are associated with other primary coils 120 may continue to ping for the presence of a second wireless power reception apparatus.

Each transmission controller 144 may be configured to detect the presence of a secondary coil 160 of a wireless power reception apparatus 150 in proximity to a corresponding one of the primary coils 120. For example, a transmission controller 143 may cause its associated primary coil 122 to periodically transmit a detection signal and measure for a change in coil current or load that indicates an object near the primary coil. In some implementations, the transmission controller 143 may detect a ping, wireless communication, load modulation, or the like, to determine that a secondary coil 163 of a wireless power reception apparatus 150 is near the primary coil 122.

In FIG. 1, the wireless power reception apparatus 150 may include any type of device capable of receiving wireless power, such as a mobile phone, computer, laptop, peripheral, gadget, robot, vehicle, or the like. The wireless power reception apparatus 150 may have one or more secondary coils 160. The secondary coils 160 may each be capable of receiving wireless power from a different primary coil 120. For example, when a first secondary coil 161 is positioned near the first primary coil 121, the transmission controller 142 may detect its presence. For example, during a detection phase, the first primary coil 121 may transmit a detection signal (which also may be referred to as a ping). The coil current at the first primary coil 121 may be measured to determine whether the coil current has crossed a threshold indicating an object in the electromagnetic field of the first primary coil 121. If an object is detected, the first transmission controller 142 may wait for a handshake signal from the wireless power reception apparatus 150 (such as an identification signal or setup signal) to determine whether the object is a wireless power reception apparatus or a foreign object. The handshake signal may be communicated by the wireless power reception apparatus 150 using a series of load changes (such as load modulations). The load changes may be detectable by a sensing circuit and interpreted by the first primary coil 121. The first primary coil 121 may interpret the variations in the load to recover the communication from the wireless power reception apparatus 150. The communication may include information such as charging level, control error, requested voltage, received power, power capability, support for a wireless charging standard, or the like.

In the wireless power reception apparatus 150, each of the secondary coils 160 may be part of a separate receiver circuit. For example, each receiver circuit may include one or more secondary coils 160, a rectifier 170, and a receiver controller 171. Each secondary coil 160 that is aligned to a primary coil 120 may generate an induced voltage based on the received wireless power signal from the primary coil 120. A capacitor may be in series between the secondary coil 160 and the rectifier 170. The rectifier 170 may rectify the induced voltage and provide the induced voltage to a power combination circuit 185 that combines power from multiple secondary coils. The power combination circuit 185 may provide a combined wireless power to a power regulating circuit 197. The power regulating circuit 197 may be managed by a power controller 195. The power regulating circuit 197 may include a voltage sensor that measures voltage at the input of the power regulating circuit, an inductor, a current controlling switch, and a current sensor. The current controlling switch (not shown in FIG. 1) may be capable of varying the current output by adjusting a gate pulse according to a duty cycle or switch frequency. The power regulating circuit 197 may provide power to the load 190 through a power output 187. The load 190 can be a battery, a circuit, or other type of power consuming electronics. If the load 190 includes a battery, the power regulating circuit 197 may function as a battery charger. The load 190 may be in the wireless power reception apparatus 150 or may be an external device that is coupled by an electrical interface, such as a power output 187 of the wireless power reception apparatus 150. The load 190 may include a battery, a BMS, electronic circuits for operating an electronic device, or any combination thereof. In some implementations, the load 190 may include protection circuits such as a temperature-detecting circuit, an overvoltage protection circuit and an overcurrent protection circuit.

In some implementations, the receiver controller 171 may contain modulation and demodulation circuits to wirelessly communicate to a corresponding transmission controller 144. For example, the receiver controller 171 may wirelessly communicate with the transmission controller 143 using an out-of-band communication link (not shown). Alternatively, or additionally, the receiver controller 171 may use load modulation to communicate via an in-band communication link that includes a respective one of the secondary coils 160. The receiver controller 171 also may include a controller for a series switch that may connect/disconnect its associated secondary coil 160 to a common output and copper connections to communicate with the power controller 195. The receiver controller 171 may use voltage-to-current (V-I) characteristics to determine the current/power needed to meet a voltage requirement at an output of a rectifier. The receiver controller 171 may communicate the current or power needed to the wireless power transmission apparatus 110 for actions to be taken by the transmission controller 142 to meet the rectifier voltage demand.

Depending on the position of one or more of the secondary coils 160 in relation to the primary coils 120, particular ones of the secondary coils 160 may be aligned with a corresponding one of the primary coils 120. For example, in FIG. 1, the secondary coil 161 may be aligned with a primary coil 121, but a second secondary coil 163 may not be aligned with a second primary coil 122. A determination that a secondary coil 160 is properly aligned may be based on an efficiency metric or communication with a corresponding primary coil 120. In the example of FIG. 1, the secondary coil 163 may be deactivated because it does not have a good electromagnetic coupling with the primary coil 122. The wireless power transmission apparatus 110 may determine which of the primary coils 120 will transmit wireless power. The transmission controller 142 connected to the primary coil 121 of the wireless power transmission apparatus 110 may latch the primary coil 121 to provide wireless power to the wireless power reception apparatus 150. The transmission controller 143 may disable or switch-off the primary coil 122 due to poor alignment or low efficiency of wireless power transfer.

The wireless power reception apparatus 150 also includes a power controller 195. The power controller 195 can detect various conditions in the wireless power reception apparatus 150. The power controller 195 can determine a demanded current associated with a load. For example, the power controller 195 may receive an indication of the demanded current from a BMS of the load 190 or other component of the wireless power reception apparatus 150. The power controller 195 also can detect voltage received from the power combination circuit 185. The power controller 195 also can detect how many secondary coils 160 are presently latched with corresponding ones of the primary coils 120 based on sensors in the receiver controllers 171. The power controller 195 also can detect when particular ones of the secondary coils 160 de-latch from corresponding ones of the primary coils 120 based on the sensors in the receiver controllers 171. If a secondary coil de-latches, the power controller 195 can detect a drop in the voltage received by the power combination circuit 185. The power controller 195 can reduce current drawn by the power combination circuit 185 by controlling one or more current references in the power combination circuit 185. By reducing the current draw, the power controller 195 can eliminate over currents and avoid system failure.

The power controller 195 may communicate with the receiver controllers 171 to determine which secondary coils 160 are latched or to manage the amount of power to receive via the secondary coils 160. For example, each receiver controller 171 may provide a signal to the power controller 195 that indicates whether its respective secondary coil is latched or de-latched. The power controller 195 may receive the signal via an input of the power controller 195. As with other power controller 195 communications described in this disclosure, the signal may be a binary-type line signal (such as on or off), a modulated signal, an analog signal, or a structured communication. Although the receiver controllers 171 and the power controller 195 are shown as separate blocks, in some implementations they may reside in one unit such as a processor or microcontroller.

Based on conditions in the wireless power reception apparatus 150, the power controller 195 can determine a lower current at which the wireless power reception apparatus 150 can continue providing power to the load 190. The conditions can relate to a voltage drop, a reduced number of latched secondary coils, reduced demanded current of the load 190, and more. The power controller 195 include inputs that receive signals from various components of the wireless power reception apparatus 150, such as the receiver controllers 171, voltage sensors, and current sensors, among other examples. The power controller 195 may include outputs that sent signals to various components of the wireless power reception apparatus 150, such as the receiver controllers 171, the power combination circuit 185, and a BMS (not shown), among other examples.

In some implementations, the power controller 195 can send a communication to, or receive a communication from, the BMS. For example, the power controller 195 may notify the BMS that power will be reduced after detecting that a previously latched coil pair has become de-latched. The power controller 195 may send a communication to the BMS regarding an amount of power that can be provided by the remaining latched coil pairs. The power controller 195 also may be capable of receiving a communication from the BMS regarding a demanded current of the load.

In some instances, the power controller 195 may determine it can meet a demanded current of the load 190 with fewer latched coil pairs. To reduce the number of latched coil pairs, the power controller 195 can cause one or more of the receiver controllers 171 to adjust an amount of power that its respective secondary coil should receive. The receiver controllers 171 may exchange power information with a corresponding transmission controller 144 to modify an amount of power received via particular coil pairs. When the power controller 195 determines that fewer latched coil pairs are needed to meet the demanded current of the load 190, the power controller 195 may cause one or more of the receiver controllers 171 to switch-off a respective secondary coil managed by that receiver controller 171.

Although the example wireless power reception apparatus 150 in FIG. 1 includes two secondary coils 160 other implementations may include any number of secondary coils 160. Similarly, the example wireless power transmission apparatus 110 is described as having two primary coils 120, but may include other quantities of primary coils in other implementations. The quantity of secondary coils 160 in the wireless power reception apparatus 150 does not need to be the same as the quantity of primary coils 120 in the wireless power transmission apparatus 110.

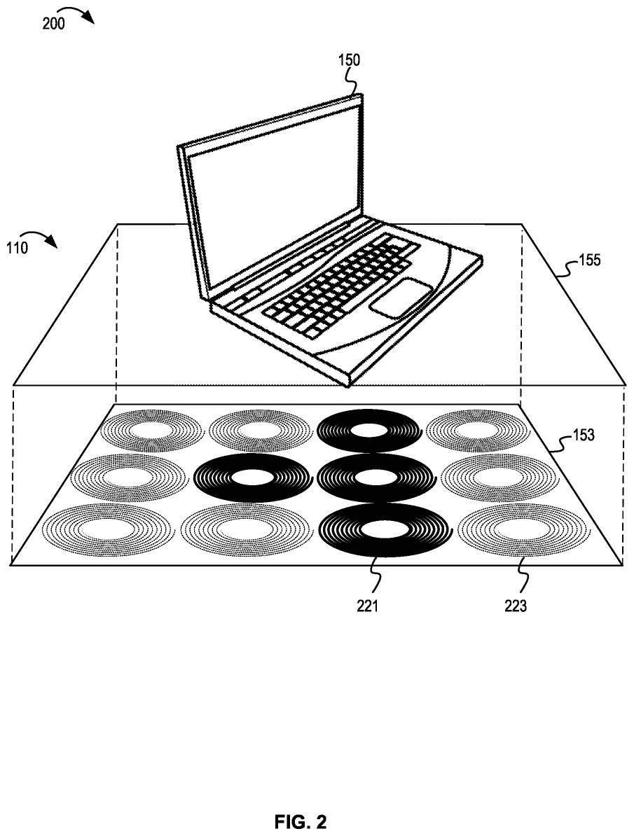

FIG. 2 shows an example wireless power system 200 that includes a wireless power reception apparatus 150 capable of receiving power from multiple primary coils of a wireless power transmission apparatus 110 according to some implementations. The example wireless power transmission apparatus 110 includes 12 primary coils (shown in portion 153). However, the quantity and arrangement of primary coils are provided as an example. Other quantities of primary coils, number of layers, or arrangements may be possible. A charging surface 155 may house the primary coils. The wireless power reception apparatus 150 may be placed on the charging surface 155. Although shown as a laptop, the wireless power reception apparatus 150 may be any type of electronic device. Furthermore, the wireless power reception apparatus 150 may be a component integrated into the electronic device or may be an external component or attachment that couples to the electronic device. In FIG. 2, the wireless power reception apparatus 150 is positioned on the charging surface 155 such that a first set of primary coils 221 are activated to transmit wireless power while other primary coils (such as primary coil 223) are deactivated. The deactivated primary coils may periodically activate for ping or detection to detect for presence of a secondary coil (either due to movement of the wireless power reception apparatus 150 or from another wireless power reception apparatus, not shown). Inside the wireless power reception apparatus 150 (such as inside a bottom surface portion of the laptop), there are a plurality of secondary coils (not shown) that are latched to the activated primary coils 221.

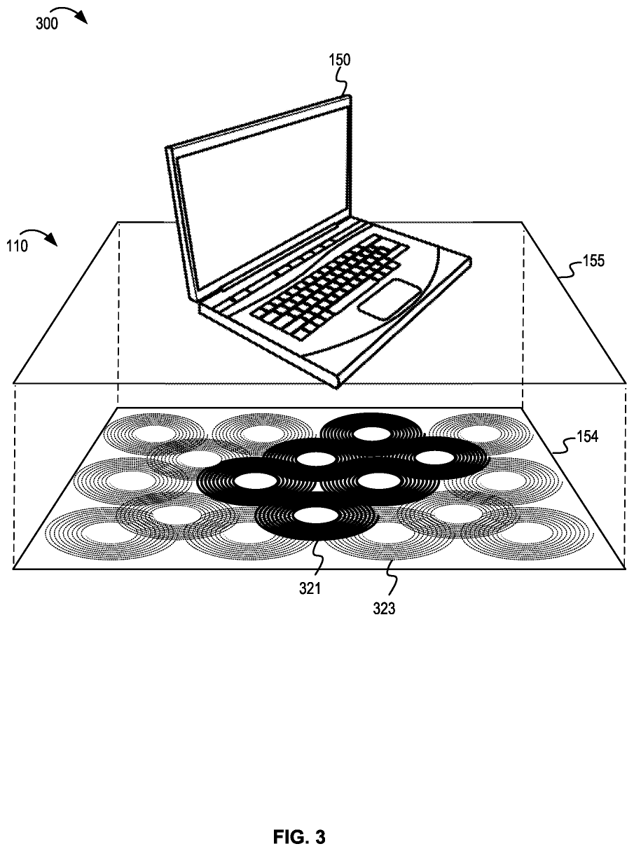

FIG. 3 shows an example wireless power system 300 in which a wireless power transmission apparatus 110 includes multiple layers of primary coils arranged in an overlapping pattern according to some implementations. The example wireless power transmission apparatus 110 includes 18 primary coils arranged in overlapping layers (shown in portion 154). The quantity and arrangement of primary coils are provided as an example. Other quantities of primary coils, number of layers, or arrangements may be possible. The wireless power reception apparatus 150 may be placed on a charging surface 155 of the wireless power transmission apparatus 110. A first set of primary coils 321 may be activated to transmit wireless power to corresponding secondary coils (not shown) in the wireless power reception apparatus 150. Other primary coils 323 may be deactivated. Although FIG. 3 shows that some of the activated coils are overlapping, in some implementations, the wireless power transmission apparatus 110 may refrain from activating overlapping coils.

In implementations when the wireless power transmission apparatus 110 or the wireless power reception apparatus 150 (or both) implement overlapping coils, the pattern of overlapping coils may reduce an amount of area where a wireless power signal is exposed (or not aligned with a secondary coil). This may have the result of reducing electromagnetic interference (EMI). Furthermore, by activating multiple primary coils 321, the amount of power contributed by each activated primary coil 321 may be lowered. Lower power transmission for each primary coil may reduce the amount of EMI and other interference to other components of the wireless power reception apparatus 150 (or the electronic device which it powers).

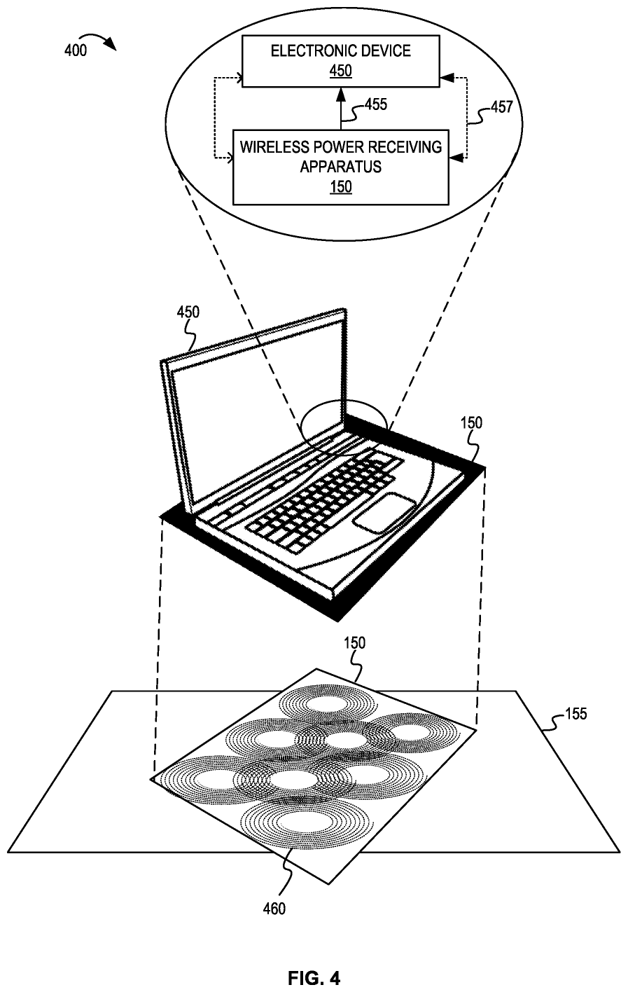

FIG. 4 shows an example wireless power system 400 in which a wireless power reception apparatus 150 is configured to provide power to an electronic device 450 according to some implementations. In FIG. 4, the wireless power reception apparatus 150 may be a wireless power pad that has multiple secondary coils 460. In the example of FIG. 4, the secondary coils are arranged in an overlapping pattern. The wireless power reception apparatus 150 may have an electrical interface 455 or other connection that provides power from the wireless power reception apparatus 150 to the electronic device 450. In some implementations, a fastener 457 (such as a clip, magnet, button, casing, or the like) may be used to physically couple the wireless power reception apparatus 150 to the electronic device 450. The fastener 457 may be part of the wireless power reception apparatus 150, the electronic device 450, or both. For example, the wireless power reception apparatus 150 include a housing that contains the secondary coils, and the housing may attach to a laptop or tablet.

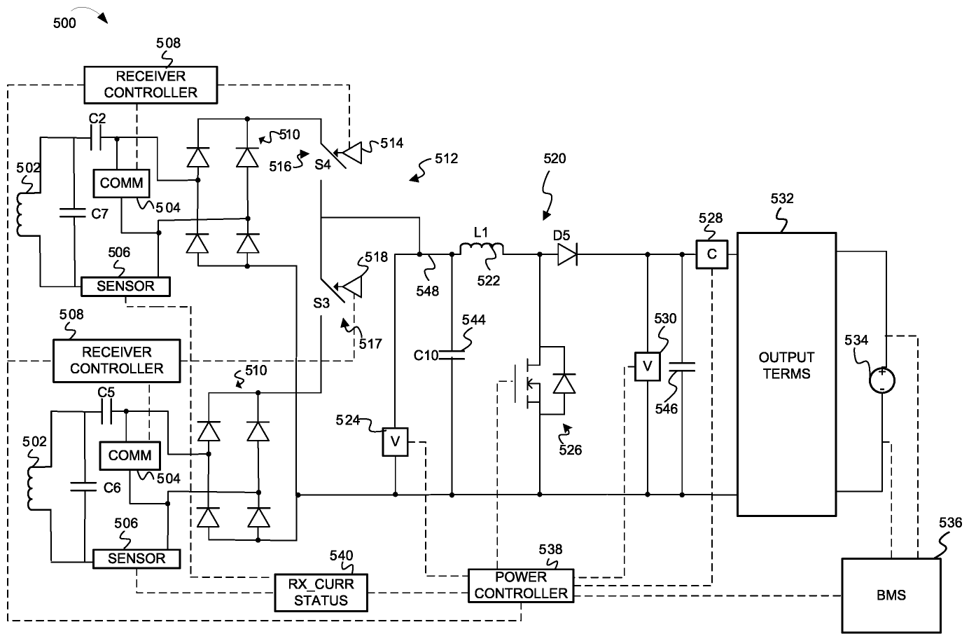

FIG. 5 is a block diagram illustrating components of an example wireless power reception apparatus 500 according to some implementations. In FIG. 5, dashed lines represent communications lines to distinguish from solid lines that represent electrical circuit lines. The wireless power reception apparatus 500 includes multiple secondary coils 502. For brevity, the illustrated wireless power reception apparatus 500 includes two secondary coils but may include any number of secondary coils. Each secondary coil 502 is connected to a communication unit 504 and a current sensor 506. Although the current sensors 506 are shown on the AC side of the rectifiers 510, they may be located on the DC side of the rectifiers 510. The communication units 504 are connected to receiver controllers 508. The receiver controllers 508 can exchange information with one or more wireless power transmission apparatuses and determine whether to receive power from particular primary coils. The receiver controllers 508 are coupled to the switch controllers 514 and 518, respectively, that also enable or disable the series switches 516 and 517, respectively, in order to connect or disconnect outputs of the rectifier 510 to a common bus 548. For example, the switch controllers 514 and 518 may be drivers to turn on or off the series switches 516 and 517, respectively. Each of the secondary coils 502 provides power to a rectifier 510. The rectifiers 510 receive alternating current power and provide direct current power to a power combination circuit 512. The power combination circuit 512 consists of rectifiers 510, series switches 516 and 517 and power regulating circuit 520. The power combination circuit 512 selectively couples the various rectifiers 510 associated with different secondary coils to the switches 516 and 517 and to the power regulating circuit 520.

The power regulating circuit 520 is managed by the power controller 538. If the load 534 were a battery, the power regulating circuit 520 may be a battery charger. The power regulating circuit 520 may include a voltage sensor 524 that measures the voltage at the input of the power regulating circuit 520, an inductor 522, current controlling switch 526, a current sensor 528, and a voltage sensor 530. The current controlling switch 526 may be capable of varying the current output by adjusting a gate pulse according to a duty cycle or switch frequency. In some implementations, the current controlling switch 526 may be referred to as a variable current switch. In some implementations, the current controlling switch 526 is a metal-oxide-semiconductor field-effect transistor. The power regulating circuit 520 provides power to a load 534 (represented as a voltage source/battery in FIG. 5) through output terminals 532.

The load can be a battery, a circuit, or other type of power consuming electronics. The output terminals 532 can include an interface through which power flows from the power regulating circuit 520 to the load 534. In some instances, a voltage sensed by the voltage sensor 524 may be lower than a voltage sensed by the output terminal voltage sensor 530. In those instances, the power regulating circuit 520 may operate as a boost type circuit. In some instances, a voltage sensed by the voltage sensor 524 is higher than the voltage sensor 530, so the power regulating circuit 520 may operate as a buck type circuit. The power regulating circuit 520 may be selected based on the relative magnitudes of voltages sensed by the voltage sensors 524 and 530, and functionally limits of the dynamic current and hence the power to the load.

A power controller 538 is connected to components of the power regulating circuit 520. As shown, the power controller 538 is connected to the current controlling switch 526, voltage sensor 524, current sensor 528, and voltage sensor 530. The power controller 538 is also connected to the receiver controllers 508 and a receiver status sensor 540. The power controller 538 can receive, from the receiver status sensor 540, status information indicating how many of the secondary coils 502 are latched with primary coils of a wireless power transmission apparatus. If one or more secondary coils 502 de-latch, the status information will indicate how many secondary coils 502 de-latched from their associated primary coils. The power controller 538 can also receive voltage and current information from the voltage sensors 524 and 530 and current sensor 528, respectively. Additionally, in some implementations, the power controller 538 can also receive, from a BMS 536, information about a demanded current for the load 534. The power controller 538 can use information from the aforementioned sensors and components to determine a gate pulse for controlling the current controlling switch 526. By controlling the current controlling switch 526 according to the gate pulse, the power controller 538 can limit current flowing through output terminals 532 and to the load 534. As the power controller 538 changes current and voltage, it can notify the BMS 536 about those changes. The power controller 538 can also notify a wireless power transmission apparatus about changes in the demanded current associated with the load 534.

In some implementations, as a demanded current of the load decreases, the power controller 538 may cause the wireless power transmission apparatus to reduce power transmission to the wireless power reception apparatus 500. For example, the power controller 538 can cause one or more of the receiver controllers 508 to communicate power demand information with a wireless power transmission apparatus. Based on the power demand information, the wireless power transmission apparatus can reduce an amount of power it sends to the wireless power reception apparatus 500. The power reduction may result in fewer latched secondary coils 502. In some implementations, the power controller 538 can reduce the number of latched secondary coils 502 without a reduced demanded current. In some implementations, the power controller 538 can determine how many secondary coils to latch to meet a demanded current of the load 534. If the demanded current can be met using fewer secondary coils than are presently in use, the power controller 538 can notify one or more of the receiver controllers 508 about the reduced number of coil pairs needed to meet the demanded current. For example, the power controller 538 may send a signal to cause the receiver controllers 508 to switch-off one or more of the series switches 516, 517 (using switch controllers 514, 518, respectively) based on the reduced number of coil pairs needed to meet the demanded current.

For brevity, the wireless power reception apparatus 500 in FIG. 5 includes two secondary coils 502. However, other implementations of the wireless power reception apparatus 500 may include other quantities of secondary coils 502. As the number of secondary coils 502 changes, so does the number associated devices such as rectifiers 510, switch controllers 516, and others.

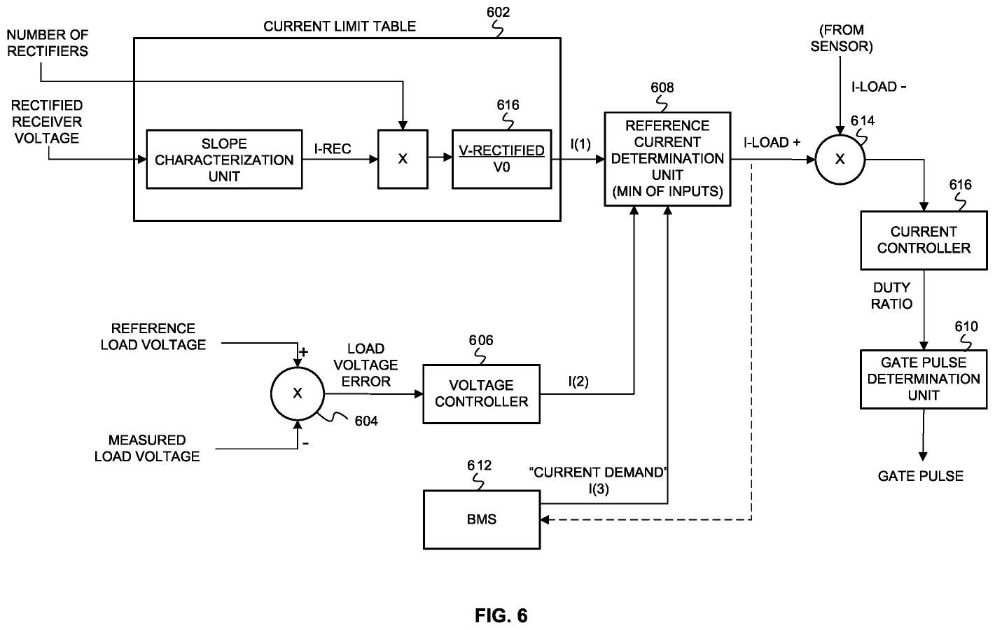

FIG. 6 is an example data flow diagram illustrating data and components used for regulating the current and voltage output of a power regulating circuit according to some implementations. In FIG. 6, the components include a current limit table 602, voltage error determination unit (which may be implemented as a comparison unit 604), voltage controller 606, a reference current determination unit 608, current error determination unit 614, current controller 616, and gate pulse determination unit 610. In some implementations, the components described with reference to FIG. 6 are part of a power controller, such as the example power controllers described with reference to FIGS. 1 and 5. FIG. 6 also shows a BMS 612 that interacts with these components.

The data flow in FIG. 6 results in a gate pulse used to limit power output from a power regulating circuit of a wireless power reception apparatus. As noted above, secondary coils of a wireless power reception apparatus may become de-latched from corresponding primary coils of a power transmission apparatus. As secondary coils de-latch, there may be a drop in the rectified receiver voltage at the common bus 548 (with reference to FIG. 5) in the wireless power receiving apparatus 500. For example, as the total rectified receiver voltage drops at the common bus 548, the power regulating circuit 520 may begin to draw current at a level similar to current levels that occur before a secondary coil de-latches from the rectified receiver voltage. Thus, the remaining latch secondary coils may draw additional current, which could cause an over-current condition, increase temperature, or otherwise adversely affect the performance of the remaining latched coil pairs. In some implementations, a power controller detects that one or more coils are de-latched and determines a gate pulse that will be used for providing a reduced current to a load. By reducing current to the load, the power controller avoids current overloads (and voltage drops) that may cause system failure. In some implementations, a power controller detects that a load has reduced its demanded current. In response, the power controller notifies a wireless power transmission apparatus to reduce its power transmission. The power controller can determine a gate pulse that reduces current relative to the reduction in wireless power received from the wireless power transmission apparatus. In some implementations, the power controller can determine a minimum number of secondary coils needed to meet a demanded current. The power controller can transmit, to a wireless power transmission apparatus, a message to the indicating the minimum number of secondary coils needed to meet a demanded current. In response, the wireless power transmission apparatus may modify its power output to utilize no more than the minimum number of secondary coils needed to meet the demanded current.

In FIG. 6, data flows from left to right. Beginning on the left, a comparison unit 604 receives a reference load voltage value and a measured load voltage value. Referring to the example implementation described with reference to FIG. 5, the measured load voltage may be measured by the voltage sensor 530. The reference load voltage may be a nominal voltage that is required by a load. Referring back to FIG. 6, the comparison unit 604 determines a load voltage error based, at least in part, on the reference load voltage and the measured load voltage. In some implementations, the load voltage error is a difference between the reference load voltage and the measured load voltage. The comparison unit 604 forwards the load voltage error to a voltage controller 606, which may determine a reference current that may be used for voltage regulation. The reference current may be based, at least in part, on the load voltage error. The voltage controller 606 serves as a feedback mechanism that provides a required reference current to correct the load voltage error. The voltage controller 606 may be implemented using a Proportional Integral controller, a lead lag controller, or a table-based controller.

Also beginning on the left of FIG. 6, the current limit table 602 receives a receiver status and a rectified receiver voltage to determine a load current limit. In the example implementation described with reference to FIG. 5, the receiver status may indicate how many of the rectifiers 510 are receiving power and hence how many secondary coils are latched to corresponding primary coils. For example, the receiver status may be based on current measurements provided by the current sensors 506 that connected with the secondary coils 502. In the example implementation of FIG. 5, the rectified receiver voltage may be based on voltage values provided by the voltage sensor 524. Based on the receiver status and the rectified receiver voltage, the current limit table 602 may provide a limit value to the load current controller 616. For example, current limit table 602 may include a lookup table including limit values that are indexed by the receiver status and the rectified receiver voltage. The current limit table 602 can be implemented as a data structure in a memory device. In some implementations, the current limit table 602 may be organized as a table of limit values. In other implementations, the current limit table 602 can organized in any other manner suitable for storing information and include any information suitable for determining limit values. The current limit table 602 is also fed as second of the inputs to the reference current determination unit 608.

The BMS 612 may provide the reference current determination unit 608 with the load current demand from the BMS 612. The load current demand is a third input (shown as I(3) in FIG. 6) to the current determination unit 608. The reference current determination unit 608 may determine the minimum of the first, second and third currents (i.e., 41), I(2), and I(3), respectively, in FIG. 6) as the reference load current (shown as “I-load+” in FIG. 6). This reference load current also may be communicated back to the BMS 612. By forwarding the reference current to be produced, the power controller is notifying the BMS 612 about a change in power provided to a load. Continuing with the current control aspect of FIG. 6, the reference load current is provided to a current error determination circuit 614 to which the actual load current is also provided. The current error is provided to the current controller 616 which determines a duty ratio fora current controlling switch (such as the current controlling switch 526). Using the duty ratio, the gate pulse determination unit 610 may generate a gate pulse for the current controlling switch.

The gate pulse determination unit 610 determines a gate pulse based, at least in part, on the duty ratio received from the current determination unit 608. The power controller may use the gate pulse to control a current controlling switch that controls current provided from a power regulating circuit to a load. Referring to the example described with reference to FIG. 5, the power controller 538 may control the current controlling switch 526 according to the gate pulse. By controlling the current controlling switch 526 according to the gate pulse, the power controller 538 controls current provided to the load 534.

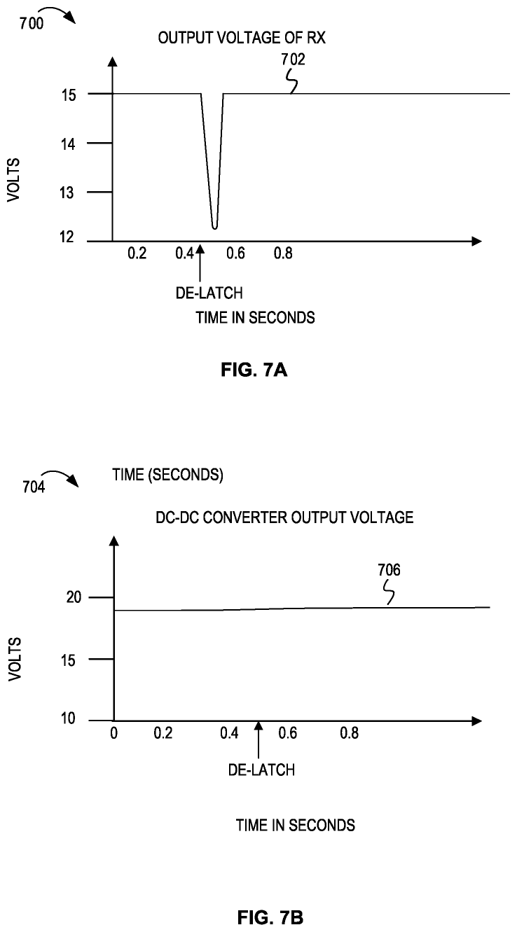

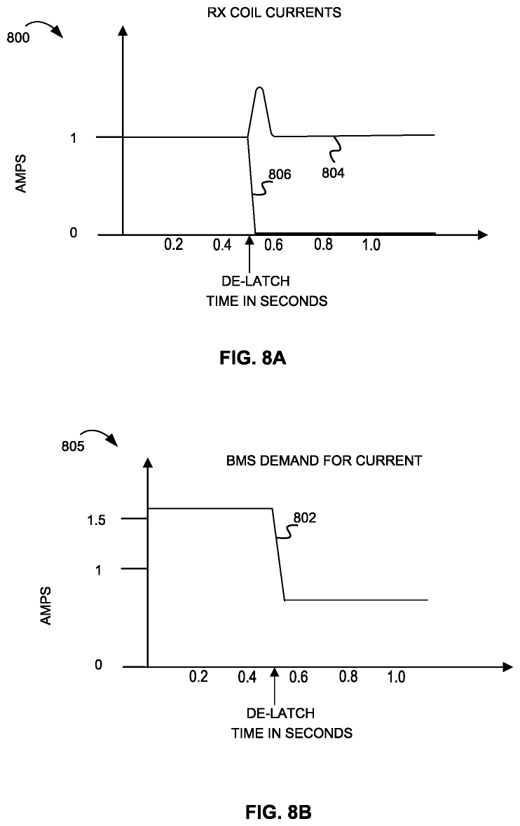

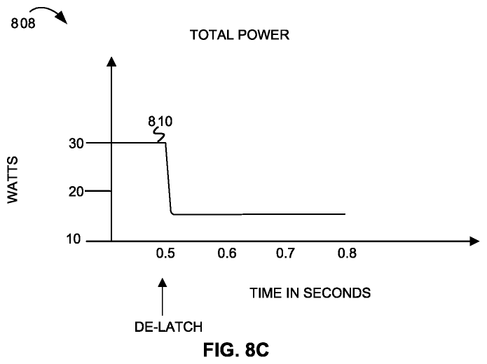

FIGS. 7A, 7B, 8A, and 8B shows performance characteristics of a power controller (in a wireless power reception apparatus) responding to voltage drops and other power changes in a wireless power system. In some implementations, the power controller can detect when one or more secondary coils de-latch from associated primary coils. As one or more coils de-latch, the power controller can avoid system failure by limiting current output of a power regulating circuit in the wireless power reception apparatus. By avoiding system failure, the wireless power reception apparatus can continue providing power to a load without interruption. In some instances, after one or more secondary coils de-latch from associated primary coils, the wireless power transmission apparatus provides a reduced power to the load. In other instances, the wireless power transmission apparatus provides the same amount of power after one or more secondary coils de-latch from associated primary coils.

FIG. 7A illustrates an example graph showing voltage in a wireless power reception apparatus according to some implementations. In FIG. 7A, a graph 700 describes a scenario where a wireless power reception apparatus includes two secondary coils that are initially latched with two primary coils of a power transmission apparatus. In the scenario, the wireless power reception apparatus is providing 30 W of power at 19 volts (V) to a battery-backed to load. A BMS is demanding 1.57 A of current. As time moves forward, one secondary coil de-latches from a corresponding primary coil.

The graph 700 includes a voltage curve 702 representing voltage values at the common bus, such as at the input of the power regulating circuit in a wireless power reception apparatus. In the graph 700, an X-axis indicates a progression in time and a Y-axis indicates increasing voltage. At time=0 (in the graph), while the two secondary coils are latched, the wireless power reception apparatus measures and output voltage of 15 V. As time approaches 0.5 seconds, one of the secondary coils de-latches from a corresponding primary coil, causing a voltage drop in the wireless power reception apparatus. The voltage curve 702 shows voltage quickly dropping from 15 V to 12.5 V. As time moves past 0.5 seconds, the voltage curve 702 shows voltage quickly increasing back to 15 V. In some implementations, a power controller detects the loss of one of the secondary coils and responds to the voltage drop (shown in the graph 700) by limiting current flowing from a power regulating circuit to a load. More specifically, in some implementations, the power controller may determine a gate pulse relative to the voltage drop and limit current by controlling a current controlling switch (in the power regulating circuit) according to the gate pulse. Although the wireless power reception apparatus experiences a momentary voltage drop, the power controller avoids system failure and restores voltage by limiting current flowing to a load.

FIG. 7B illustrates an example graph showing output voltage of a power regulating circuit in a wireless power reception apparatus according to some implementations. In FIG. 7B, a graph 704 describes a scenario where a wireless power reception apparatus includes two secondary coils that are initially latched with two primary coils of a power transmission apparatus. In the scenario, the wireless power reception apparatus is providing 30 W of power at 19 V to a battery-backed to load. A BMS is demanding 1.57 A of current. As time moves forward, one secondary coil de-latches from a corresponding primary coil.

The graph 704 includes a voltage curve 706 representing voltage values in a wireless power reception apparatus. In the graph 704, an X-axis indicates a progression in time and a Y-axis indicates increasing voltage. At time=0 (in the graph), while the two secondary coils are latched, the wireless power reception apparatus measures and output voltage of 19 V. As time approaches 0.5 seconds, one of the secondary coils de-latches from a corresponding primary coil. Thus, as a result of the power regulation circuit implementing the features described herein, the battery backed load may not experience a major voltage fluctuation as shown in voltage curve 706. [

FIG. 8A illustrates an example graph showing output current of two secondary coils, according to some implementations. FIG. 8B illustrates an example graph of a demanded current of a BMS, according to some implementations. In FIGS. 8A and 8B, the graphs 800 and 805 together describe a scenario where a wireless power reception apparatus includes two secondary coils that are initially latched with two primary coils of a power transmission apparatus. In the scenario, the wireless power reception apparatus is providing 30 W of power at 19 V to a battery-backed to load. A BMS is demanding 1.57 A of current. As time moves forward, one secondary coil de-latches from a corresponding primary coil.

The graph 800 includes a first secondary coil current curve 806 and a second secondary coil current curve 804. The graph 805 (FIG. 8B) includes a BMS demanded current curve 802. The BMS demanded current is with reference to the output voltage at 19 V whereas the secondary coil currents are with respect to the input voltage to the power regulating circuit (such as 15 V). In each of the graphs 800 and 805, an X-axis indicates a progression in time and a Y-axis indicates increasing current.

At time=0, while the two secondary coils are latched, each secondary coil has an output current of 1 A. As time approaches 0.5 seconds, one of the secondary coils de-latches from a corresponding primary coil. The second secondary coil current curve 804 quickly rises above 1 A and then falls to approximately 1 A indicating a power contribution at a level of approximately 15 W. The first secondary coil current curve 806 falls to 0 A and remains at 0 A. The BMS demanded current curve 802 shows current dropping from approximately 1.57 A to 0.78 A, indicating a reduction in demand from more than 30 W (19 V*1.57 A) to about 15 W (19 V*0.78 A). As time passes 0.6 seconds, the BMS demanded current curve 802 stabilizes. Therefore, the wireless power reception apparatus can recover from a de-latching secondary coil without failing.

FIG. 8C illustrates an example graph showing output power of a wireless power reception apparatus according to some implementations. In FIG. 8C, a graph 808 describes a scenario where a wireless power reception apparatus includes two secondary coils that are initially latched with two primary coils of a power transmission apparatus. In the scenario, the wireless power reception apparatus is providing 30 W of power at 19 V to a battery-backed to load. A BMS is demanding 1.57 A of current. As time moves forward, one secondary coil de-latches from a corresponding primary coil.

The graph 808 includes a power curve 810 representing power values in a wireless power reception apparatus. In the graph 808, an X-axis indicates a progression in time and a Y-axis indicates increasing power. At time=0, while the two secondary coils are latched, the wireless power reception apparatus measures and output voltage of 19 V. As time approaches 0.5 seconds, one of the secondary coils de-latches from a corresponding primary coil causing a drop in output power from a power regulating circuit. The power curve 810 shows power quickly dropping from 30 W to approximately 15 W. As time passes 0.5 seconds, the power curve 810 shows power recovering to slightly more than 15 W. As time approaches 0.7 seconds, the power curve 810 stabilizes at approximately 15 W. After one of the secondary coils de-latches from a primary coil, a power controller can respond to the voltage drop by limiting current flowing from a power regulating circuit to a load. The power curve 810 shows that the wireless power reception apparatus did not fail but instead recovered from the voltage drop. The wireless power reception apparatus used power from a single latched secondary coil to provide 15 W of power to the load.

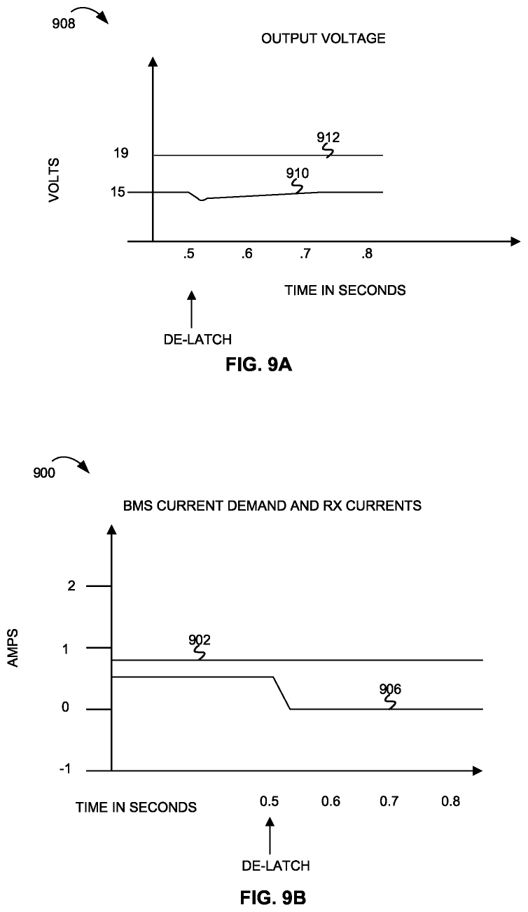

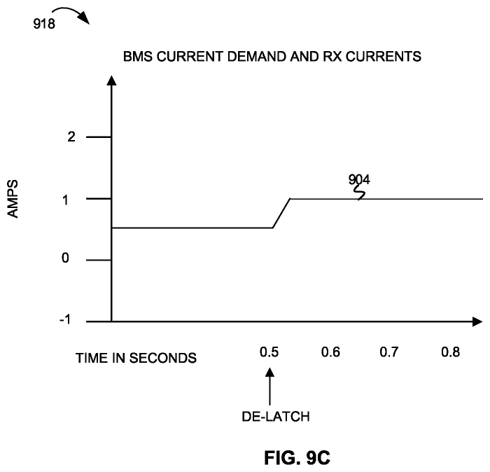

FIGS. 9A and 9B describe performance characteristics of a power controller that can optimize resource utilization. In some implementations, the power controller can reduce a number of latched secondary coils used for meeting a demanded current. The power controller may notify a wireless power transmission apparatus about a reduced number of latched coil pairs needed to meet the demanded current. In response, the wireless power transmission apparatus may modify its power transmission to the wireless power reception apparatus. The modified power may be lower, so the wireless power system may consume less power. Also, the wireless power reception apparatus may have fewer secondary coils latched with the primary coils. The following graphs describe how implementations of a power controller respond to power optimizations that involve fewer latched coils.

FIG. 9A illustrates an example graph showing Rx output voltage and DC-DC converter output voltage in a wireless power reception apparatus. In FIG. 9A, a graph 908 describes a scenario where two secondary coils are initially latched with two primary coils and then a secondary coils de-latches from a corresponding primary coil. Initially, the two secondary coils are supplying power to a power regulating circuit which is providing 14 W of power at 19 V to a battery-backed to load. Each of the secondary coils is providing 7 W at 15 V (0.475 A) to the power regulating circuit. A BMS is demanding 0.7 A of current at 19 V. Initially, while the two secondary coils are latched, the power regulating circuit measures an output voltage of 15 V.

The graph 908 includes a voltage curve 910 representing voltage values for secondary coils in the wireless power reception apparatus. An X-axis indicates a progression in time (seconds) and a Y-axis indicates increasing voltage. At time=0, the voltage for the latched secondary coils is 15 V. At time nears 0.5 seconds, one of the secondary coils is switched-off or de-latches from a corresponding primary coil. The voltage curve 910 shows a subtle voltage drop at time=0.5 seconds, but the voltage curve steadily climbs back to 15V by time=0.7 seconds and remains there. Despite a secondary coil de-latching (for resource optimization), the power controller maintains voltage at approximately 15 V with a brief and subtle reduction in voltage that is not long enough to cause the remaining latched coil pairs to become switched-off or de-latched. Hence, the power controller avoids a voltage drop and enables the remaining latched secondary coil to continuously provide approximately 15 V to a power regulating circuit in the wireless power transmission apparatus.

The graph 908 also includes a voltage curve 912 representing power output from a power regulating circuit in the wireless power reception apparatus. Despite the secondary coil being switched off or de-latching (at time=0.5), the power controller enables the power regulating circuit to maintain a power output voltage of 19 V. Although not shown, the power output from the power regulating circuit remains at a constant 14 W. As a result, the power controller enables the wireless power reception apparatus to continuously provide 14 W of power while reducing the number of latched secondary coils used for providing the 14 W of power.

FIG. 9B illustrates an example graph showing current output of a first secondary coil and a demanded current of a BMS, according to some implementations. FIG. 9C illustrates an example graph showing current output of a second secondary coil, according to some implementations. In FIGS. 9B and 9C, graphs 900 and 918 together describe a scenario where two secondary coils are initially latched with two primary coils and then a secondary coils de-latches from a corresponding primary coil. The graph 900 (FIG. 9B) includes a BMS demanded current curve 902 representing an amount of current demanded by a BMS at 19 V. The graph 900 also includes a first secondary coil voltage curve 906. The graph 918 (FIG. 9C) includes a second secondary coil voltage curve 904. In each of the graphs 900 and 910, an X-axis indicates a progression in time and a Y-axis indicates increasing current.

At time=0, the wireless power reception apparatus includes two secondary coils that have latched with two primary coils of a wireless power transmission apparatus. At time=0, each of the secondary coils is supplying 0.475 A of current to the input of the power regulating circuit at 15 V. At time=0, the BMS is demanding 0.7 A of current at the output of the power regulating circuit at 19 V. As time passes 0.5 seconds, one of the secondary coils de-latches from a corresponding primary coil, causing a drop in output voltage of the secondary coils. The second secondary coil voltage curve 904 represents current of the latched secondary coil, whereas the first secondary coil voltage curve 906 represents current of the de-latched secondary coil. The second secondary coil voltage curve 904 quickly rises to 0.93 A and remains at 0.93 A. The first secondary coil voltage curve 906 falls to 0 A and remains at 0 A. The BMS demanded current curve 902 remains constant at 0.7 A. The power controller enables the first secondary coil to continuously meet the BMS demanded current while reducing the number of latched secondary coils.

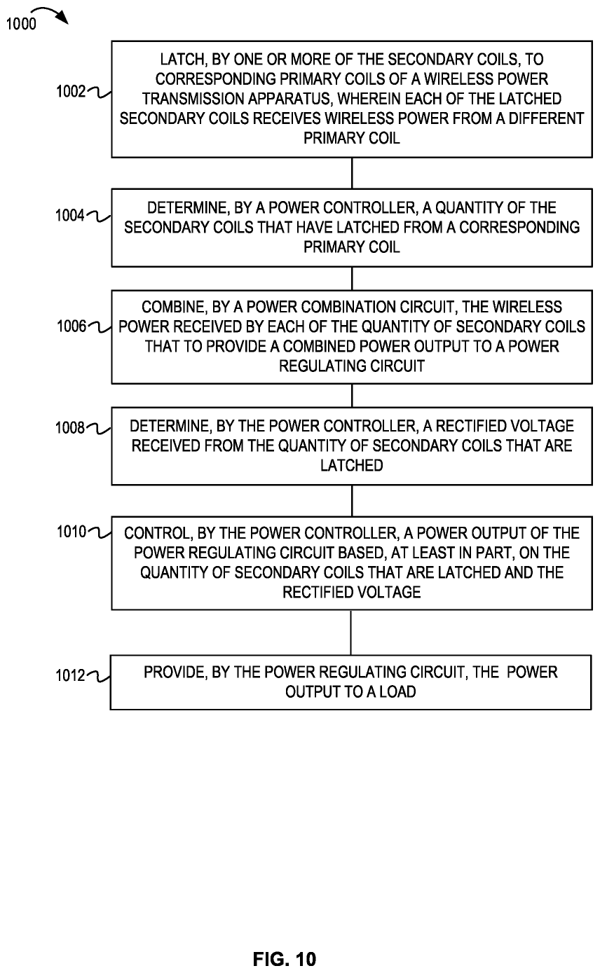

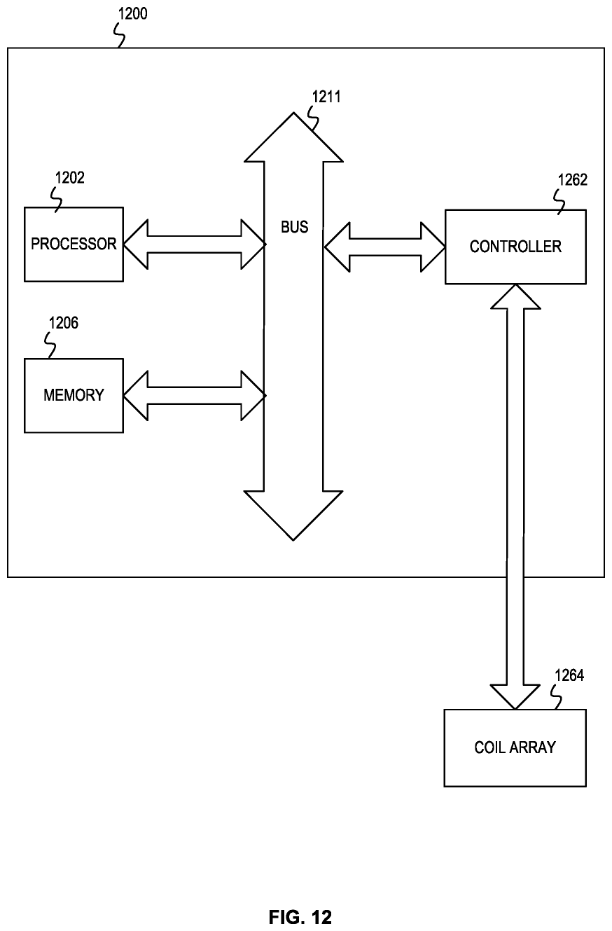

FIG. 10 is a flow diagram illustrating example operations of a process 1000 for controlling a wireless power transmission apparatus according to some implementations. For brevity, the operations are described as performed by an apparatus. The operations of process 1000 may be implemented by a wireless power reception apparatus or power controller as described herein. For example, the process 1000 may be performed by the wireless power reception apparatus 150 or the power controller 195 described with reference to FIG. 1, the wireless power reception apparatus 500 or the power controller 538 described with reference to FIG. 5, or the apparatus 1200 described with reference to FIG. 12.

At block 1002, the apparatus may latch, by one or more of the secondary coils, to corresponding primary coils of a wireless power transmission apparatus, wherein each of the latched secondary coils receives wireless power from a different primary coil.

At block 1004, the apparatus may determine, by a power controller, a quantity of the secondary coils that have latched from a corresponding primary coil.

At block 1006, the apparatus may combine, by a power combination circuit, the wireless power received by each of the quantity of secondary coils that to provide a combined power to a power regulating circuit.

At block 1008, the apparatus may determine, by the power controller, a rectified voltage received from the quantity of secondary coils that are latched.

At block 1010, the apparatus may control, by the power controller, a power output of the power regulating circuit based, at least in part, on the quantity of secondary coils that are latched and the rectified voltage.

At block 1012, the apparatus may provide, by the power regulating circuit, the power output to a load.

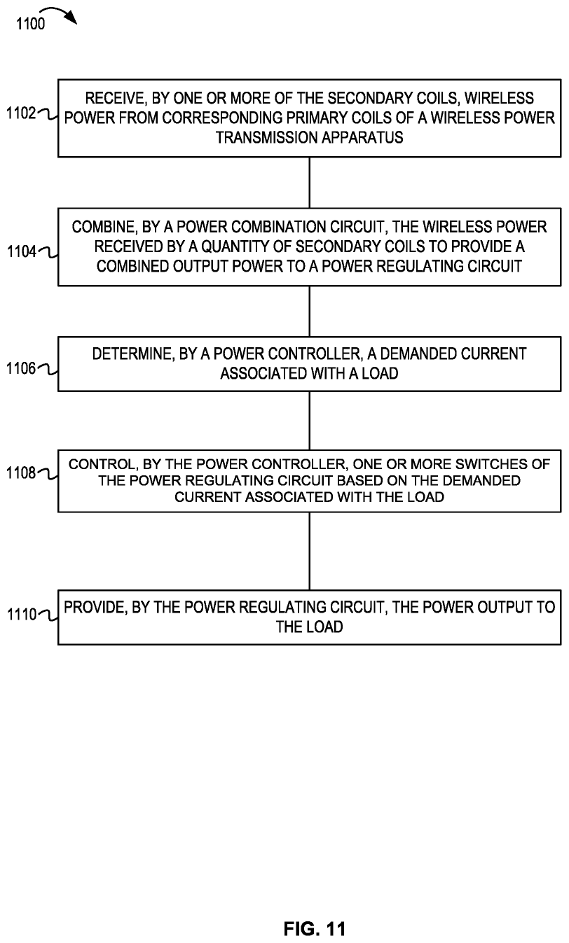

FIG. 11 is a flow diagram illustrating example operations of a process 1100 for controlling a wireless power transmission apparatus according to some implementations. The operations of process 1100 may be implemented by a wireless power reception apparatus or power controller as described herein. For example, the process 1000 may be performed by the wireless power reception apparatus 150 or the power controller 195 described with reference to FIG. 1, the wireless power reception apparatus 500 or the power controller 538 described with reference to FIG. 5, or the apparatus 1200 described with reference to FIG. 12.

At block 1102, the apparatus may receive, by one or more of the secondary coils, wireless power from corresponding primary coils of a wireless power transmission apparatus

At block 1104, the apparatus may combine, by a power combination circuit, the wireless power received by a quantity of secondary coils to provide a combined output power to a power regulating circuit.

At block 1106, the apparatus may determine, by a power controller, a demanded current associated with a load.

At block 1108, the apparatus may control, by the power controller, one or more switches of the power regulating circuit based on the demanded current associated with the load.

At block 1112, the apparatus may provide the power output to the load.

FIG. 12 shows a block diagram of an example apparatus for use in wireless power system according to some implementations. In some implementations, the apparatus 1200 may be a wireless power transmission apparatus (such as the wireless power transmission apparatus 110) or a wireless power reception apparatus (such as the wireless power reception apparatus 150). The apparatus 1200 can include a processor 1202 (possibly including multiple processors, multiple cores, multiple nodes, or implementing multi-threading, etc.). The apparatus 1200 also can include a memory 1206. The memory 1206 may be system memory or any one or more of the possible realizations of computer-readable media described herein. The apparatus 1200 also can include a bus 1211 (such as PCI, ISA, PCI-Express, HyperTransport®, InfiniBand®, NuBus,® AHB, AXI, etc.).

The apparatus 1200 may include one or more controller(s) 1262 configured to manage multiple primary or secondary coils (such as a coil array 1264). In some implementations, the controller(s) 1262 can be distributed within the processor 1202, the memory 1206, and the bus 1211. The controller(s) 1262 may perform some or all of the operations described herein. For example, the controller(s) 1262 may be a power controller, such as the power controller 195 described with reference to FIG. 1 or the power controller 538 described with reference to FIG. 5.

The memory 1206 can include computer instructions executable by the processor 1202 to implement the functionality of the implementations described with reference to FIGS. 1-11. Any one of these functionalities may be partially (or entirely) implemented in hardware or on the processor 1202. For example, the functionality may be implemented with an application specific integrated circuit, in logic implemented in the processor 1202, in a co-processor on a peripheral device or card, etc. Further, realizations may include fewer or additional components not illustrated in FIG. 12. The processor 1202, the memory 1206, and the controller(s) 1262 may be coupled to the bus 1211. Although illustrated as being coupled to the bus 1211, the memory 1206 may be coupled to the processor 1202.

FIGS. 1-12 and the operations described herein are examples meant to aid in understanding example implementations and should not be used to limit the potential implementations or limit the scope of the claims. Some implementations may perform additional operations, fewer operations, operations in parallel or in a different order, and some operations differently.

The figures, operations, and components described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A wireless power reception apparatus comprising:
a plurality of secondary coils, each secondary coil configured to receive wireless power from at least one primary coil of a wireless power transmission apparatus and to provide the wireless power to a power combination circuit;
the power combination circuit configured to combine the wireless power received by the plurality of secondary coils and provide a combined power to a power regulating circuit;
the power regulating circuit configured to receive the combined power from the power combination circuit and provide a power output to a load; and
a power controller configured to control the power output of the power regulating circuit based, at least in part, on a quantity of secondary coils, from among the plurality of secondary coils, that are latched with different primary coils of the wireless power transmission apparatus.

2. The wireless power reception apparatus of claim 1, wherein the power controller is further configured to:
determine the quantity of secondary coils that are latched with different primary coils of the wireless power transmission apparatus; and
determine a rectified voltage received from the quantity of secondary coils that are latched.

3. The wireless power reception apparatus of claim 1, where the power controller is further configured to:
determine the quantity of secondary coils that are latched; and
control the power output of the power regulating circuit by controlling a current limiting switch of the power regulating circuit.

4. The wireless power reception apparatus of claim 1, wherein the power output is provided to a battery managed by a battery management system.

5. The wireless power reception apparatus of claim 4, wherein the power controller is further configured to communicate information about the power output to the battery management system.

6. The wireless power reception apparatus of claim 1, wherein the power controller is further configured to receive information about the quantity of secondary coils that are latched with different primary coils of the wireless power transmission apparatus from a receiver status sensor that receives information from sensors associated with the secondary coils.

7. The wireless power reception apparatus of claim 1, wherein the power controller is further configured to
detect de-latching of one or more of the secondary coils from a corresponding primary coil of the wireless power transmission apparatus; and
adjust the power output of the power regulating circuit based on how many of the secondary coils remain latched as a result of the de-latching of the one or more secondary coils.

8. The wireless power reception apparatus of claim 7, wherein the power controller is further configured to
determine how many secondary coils remain latched with corresponding primary coils of the wireless power transmission apparatus; and
disconnect one or more of the latched secondary coils while continuing to maintain the power output provided by the remaining latched secondary coils.

9. A wireless power reception apparatus comprising:
a plurality of secondary coils, each secondary coil configured to receive wireless power from one or more primary coils of a wireless power transmission apparatus and to provide the wireless power to a power combination circuit;
the power combination circuit configured to combine the wireless power received by a quantity of secondary coils and provide a combined power to a power regulating circuit;
the power regulating circuit configured to receive the combined power from the power combination circuit and provide a power output to a load; and
a power controller configured to control one or more switches of the power regulation circuit to control the power output of the power regulating circuit based on a demanded current associated with the load.

10. The wireless power reception apparatus of claim 9, wherein the power controller is further configured to:
determine the demanded current associated with the load; and
determine a quantity of secondary coils to receive wireless power based, at least in part, on the demanded current associated with the load.

11. The wireless power reception apparatus of claim 10, further comprising:
one or more receiver controllers configured to manage the plurality of secondary coils, wherein the power controller is further configured to communicate with the one or more receiver controllers to cause the quantity of secondary coils to receive the wireless power from one or more corresponding primary coils.

12. The wireless power reception apparatus of claim 11, wherein the power controller is further configured to:
cause the quantity of secondary coils to remain latched to corresponding primary coils, and
cause one or more other secondary coils of the plurality of secondary coils to switch off.

13. The wireless power reception apparatus of claim 9, wherein the load includes a battery managed by a battery management system, and wherein the power controller is further configured to receive information about the demanded current associated with the load from the battery management system.

14. The wireless power reception apparatus of claim 9, wherein the power controller is further configured to:
determine a gate pulse for the one or more switches of the power regulating circuit based, at least in part, on the demanded current associated with the load.

15. A method for controlling a wireless power reception apparatus including a plurality of secondary coils, the method comprising:
latching, by one or more of the secondary coils, to corresponding primary coils of a wireless power transmission apparatus, wherein each of the latched secondary coils receives wireless power from a different primary coil;
determining, by a power controller, a quantity of the secondary coils that have latched from a corresponding primary coil;
combining, by a power combination circuit, the wireless power received by each of the quantity of secondary coils to provide a combined power to a power regulating circuit;
determining, by the power controller, a rectified voltage received from the quantity of secondary coils that are latched;
controlling, by the power controller, a power output of the power regulating circuit based, at least in part, on the quantity of secondary coils that are latched and the rectified voltage; and
providing, by the power regulating circuit, the power output to a load.

16. The method of claim 15, wherein controlling the power output of the power regulating circuit further comprises:
determining, by the power controller, a gate pulse based, at least in part, on the quantity of secondary coils that are latched; and
controlling a current controlling switch of the power regulating circuit based on the gate pulse.

17. The method of claim 15, further comprising:
receiving, by the power controller, information about the quantity of secondary coils that are latched with different primary coils of the wireless power transmission apparatus from a receiver status sensor that receives information from sensors associated with the secondary coils.

18. The method of claim 15, further comprising:
detecting a de-latching of one or more of the secondary coils from a corresponding primary coil of the wireless power transmission apparatus; and
controlling the power output of the power regulating circuit based on how many of the secondary coils remain latched as a result of the de-latching of the one or more secondary coils.

19. The method of claim 18, further comprising:
determining how many secondary coils remain latched with corresponding primary coils of the wireless power transmission apparatus; and
reducing, by the power controller, a current of the power output of the power regulating circuit based, at least in part, on how many secondary coils remain latched; and
providing the power output at the reduced current to the load.

20. A method for controlling a wireless power reception apparatus including a plurality of secondary coils, the method comprising:
receiving, by one or more of the secondary coils, wireless power from corresponding primary coils of a wireless power transmission apparatus;
combining, by a power combination circuit, the wireless power received by a quantity of secondary coils to provide a combined power to a power regulating circuit;
determining, by a power controller, a demanded current associated with the load;
controlling, by the power controller, one or more switches of the power regulating circuit based on the demanded current associated with the load; and
providing, by the power regulating circuit, a power output to the load.

21. The method of claim 20, further comprising:
determining, by the power controller, the quantity of secondary coils to receive wireless power based, at least in part, on the demanded current associated with the load.

22. The method of claim 21, wherein the plurality of secondary coils is managed by one or more receiver controllers, the method further comprising:
communicating, by the power controller, with the one or more receiver controllers to cause the quantity of secondary coils to receive the wireless power from one or more corresponding primary coils.

23. The method of claim 21 wherein communicating with the one or more receiver controllers includes:
sending a signal from the power controller to the one or more receiver controllers to cause the quantity of secondary coils to remain latched to corresponding primary coils; and
sending a signal from the power controller to the one or more receiver controllers to cause one or more other secondary coils of the plurality of secondary coils to switch off.

24. The method of claim 20 further comprising:
determining, by the power controller, a gate pulse based, at least in part, on the demanded current; and
wherein the controlling one or more switches includes controlling, by the power controller, a current controlling switch of the power regulation circuit based on the gate pulse to provide the power output.
